(19) United States
(12) Patent Application Publication
(10) Pub. No.: US 2026/0184184 A1
(43) Pub. Date: Jul. 2, 2026

(54) VEHICLE CONTROL DEVICE AND VEHICLE

(71) Applicant: Isuzu Motors Limited, Kanagawa (JP)

(72) Inventor: Yuta IKEDA, Fujisawa-shi, Kanagawa (JP)

(73) Assignee: Isuzu Motors Limited, Kanagawa (JP)

(21) Appl. No.: 18/727,700

(22) PCT Filed: Jan. 6, 2023
(86) PCT No.: PCT/JP2023/000155

§ 371 Date: Jul. 10, 2024

(30) Foreign Application Priority Data
Jan. 11, 2022 (JP) 2022-002568

(51) Int. Cl. B60L 7/10

(52) U.S. Cl. CPC B60L 7/10; B60L 2240/14; B60L 2240/26; B60L 2240/421

(57) ABSTRACT

In the present invention, a vehicle control device and a vehicle can acquire a regenerative torque that accords with the total weight of the vehicle. This vehicle control device controls a vehicle equipped with a motor generator for generating a regenerative torque that contributes to deceleration of the vehicle, and comprises a total weight calculation unit that calculates a total vehicle weight including a load weight that is the weight of a load on the loading space of the vehicle, and a control unit that controls the motor generator to change the regenerative torque according to the calculated total vehicle weight.

### TECHNICAL FIELD

The present disclosure relates to a vehicle control device and a vehicle.

### BACKGROUND ART

Electric vehicles and hybrid vehicles equipped with a motor as a drive source employ a technology known as regenerative braking, which enables deceleration through the regenerative torque generated in a motor when the accelerator is released. The regenerative torque generated in the motor allows the motor to function as a generator. The electric power generated in the motor is regenerated to a battery via an inverter.

For example, disclosed is a vehicle control device that includes a regenerative torque control means controlling a motor so that the regenerative torque is set so as to correspond to the position of a shift lever (see, for example, Patent Literature (hereinafter, referred to as PTL) 1).

### CITATION LIST

### Patent Literature

### PTL 1

Japanese Patent Application Laid-Open No. 2015-171205

### SUMMARY OF INVENTION

### Technical Problem

When the vehicle control device described in PTL 1 is applied to a vehicle such as a commercial vehicle having a large weight difference between the unloaded and loaded states of the vehicle, there is a substantial difference in the deceleration obtained from the same regenerative torque.

When the regenerative torque is set according to the loaded state of a vehicle in order to increase the amount of regeneration to the battery, the deceleration unfortunately would become too large when the vehicle is unloaded, making it impossible to obtain the deceleration desired by the user. On the other hand, when the regenerative torque is set according to an unloaded state of the vehicle, sufficient deceleration cannot be obtained, resulting in a problem such that the inter-vehicle distance between the own vehicle and the vehicle ahead becomes short.

An object of the present disclosure is to provide a vehicle control device and a vehicle each capable of obtaining regenerative torque in accordance with the overall weight of the vehicle.

### Solution to Problem

To achieve the object, a vehicle control device in the present disclosure is as follows.

A control device of a vehicle that includes a motor generator generating regenerative torque contributing to deceleration of the vehicle, the control device including:
an overall weight calculation section that calculates an overall weight of the vehicle, the overall weight including a loaded weight that is a weight of a cargo loaded on a loading platform of the vehicle; and
a control section that controls the motor generator to change the regenerative torque according to the calculated overall weight.

A vehicle in the present disclosure includes the vehicle control device described above.

### Advantageous Effects of Invention

The present disclosure enables obtainment of regenerative torque in accordance with the overall weight of a vehicle.

### BRIEF DESCRIPTION OF DRAWINGS

FIG. 1 is a configuration diagram schematically illustrating the configuration of a vehicle;

FIG. 2 is a configuration block diagram illustrating the configuration of a vehicle control device;

FIG. 3 illustrates the relationship between the rotation speed of a motor generator and regenerative torque;

FIG. 4 is a diagram of deceleration illustrating the relationship between vehicle speed and deceleration;

FIG. 5 is a flowchart illustrating an example of the operation of the vehicle control device; and

FIG. 6 is a diagram of deceleration illustrating the relationship between vehicle speed and deceleration when the magnitude of deceleration is set in three stages.

### DESCRIPTION OF EMBODIMENTS

Hereinafter, an embodiment of the present disclosure will be described with reference to the drawings.

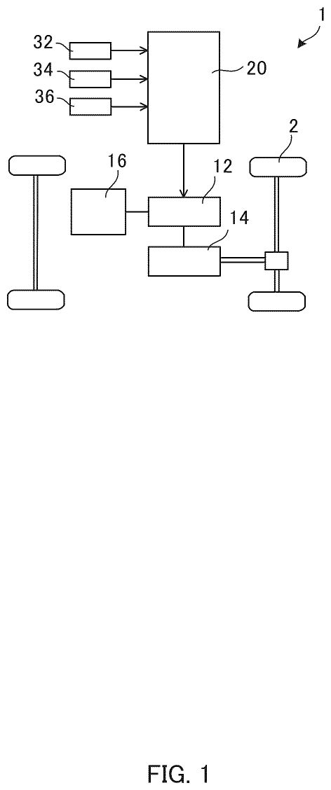

FIG. 1 is a configuration diagram schematically illustrating the configuration of vehicle 1. Vehicle 1 is an electric vehicle including drive wheels 2. Vehicle 1 includes power control section 12, motor generator 14, battery 16, control device 20, acceleration sensor 32, torque sensor 34, and rotation sensor 36.

Power control section 12 is connected to battery 16. Electric power from battery 16 is supplied to motor generator 14 via power control section 12. Motor generator 14 functions as a motor that generates rotational driving force using the supplied electric power from battery 16. The rotational driving force drives drive wheel 2.

Motor generator 14 functions as a power generator when rotational force is applied from drive wheels 2 during braking. Electric power generated by motor generator 14 is stored in battery 16 via power control section 12. When motor generator 14 generates power, motor generator 14 generates a power generation load. The amount of regeneration to the battery increases as the power generation load increases.

Motor generator 14 applies the power generation load to drive wheels 2 as regenerative torque. As a result, a braking force is generated in drive wheels 2. In other words, the regenerative torque contributes to the deceleration of vehicle 1.

Acceleration sensor 32 detects the acceleration of the vehicle (herein also simply referred to as “vehicle acceleration”). The detection result (vehicle acceleration) of acceleration sensor 32 is input to control device 20.

Torque sensor 34 detects the rotational driving force (driving force of the vehicle (herein also simply referred to as “vehicle driving force”)) of motor generator 14. The detection result of torque sensor 34 is input to control device 20.

Rotation sensor 36 detects the rotation speed and rotation direction of the motor, and the like. The detection result of rotation sensor 36 is input to control device 20.

Control device 20 includes a central processing unit (CPU), a read only memory (ROM), an electrically erasable programmable read only memory (EEPROM), a random access memory (RAM), an input port, an output port, and the like. The CPU of control device 20 loads predetermined programs stored in the ROM into the RAM and executes various functions.

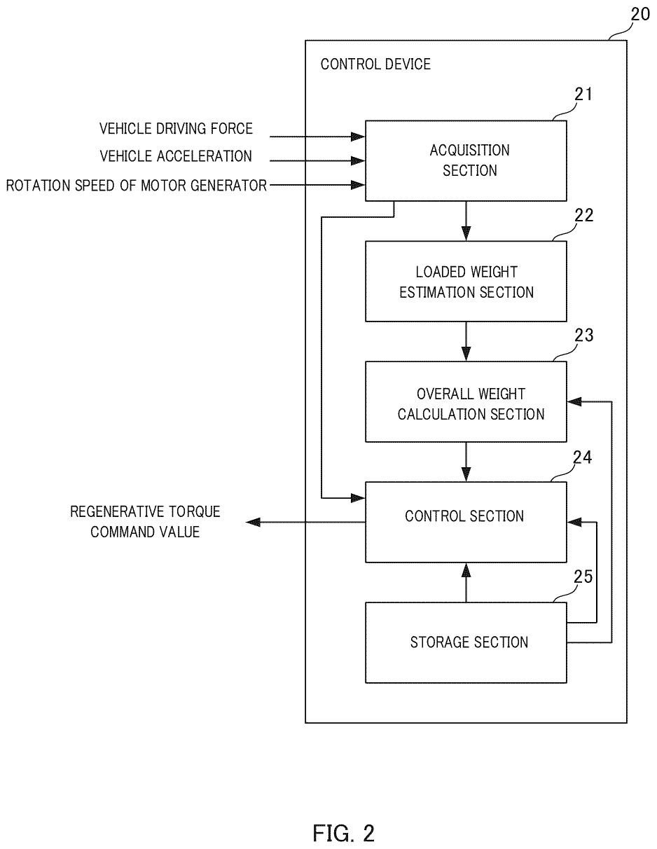

FIG. 2 is a configuration block diagram illustrating the configuration of control device 20. Control device 20 includes acquisition section 21, loaded weight estimation section 22, overall weight calculation section 23, control section 24, and storage section 25, as various functions.

Acquisition section 21 acquires the detection result (vehicle acceleration) of acceleration sensor 32. In addition, acquisition section 21 acquires the detection result (vehicle driving force) of torque sensor 34. Acquisition section 21 also acquires the detection result of rotation sensor 36 (rotation speed of motor generator 14).

Loaded weight estimation section 22 estimates the loaded weight of the cargo loaded on the loading platform based on the relationship between the vehicle acceleration and the vehicle driving force.

Overall weight calculation section 23 calculates the overall weight by adding the loaded weight estimated by loaded weight estimation section 22 to the vehicle weight stored in advance. Here, the “vehicle weight” is the weight of the vehicle itself, is constant for each vehicle type, and is stored in advance in storage section 25. Storage section 25 storing the vehicle weight data is, for example, a ROM.

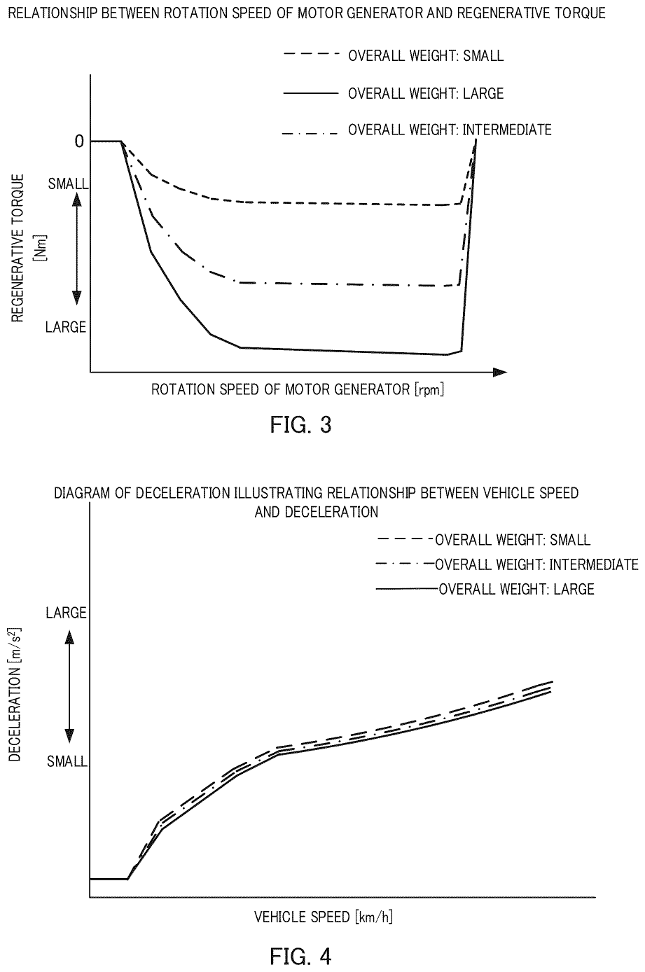

Storage section 25 stores a plurality of tables—each indicating the relationship between the rotation speed of motor generator 14 and the regenerative torque—respectively in stages according to the overall weight. FIG. 3 illustrates the relationship between the rotation speed of motor generator 14 and the regenerative torque. In FIG. 3, the horizontal axis represents the rotation speed [rpm] of motor generator 14, and the vertical axis represents the regenerative torque [Nm]. In FIG. 3, the relationship between the rotation speed of motor generator 14 and the regenerative torque is indicated by a broken line when the overall weight is relatively small, by a solid line when the overall weight is relatively large, and by a dashed-dotted line when the overall weight is intermediate between the small and large weights. The data indicated by the broken line, solid line, and dashed-dotted line illustrated in FIG. 3 can be obtained through experiments and simulations. Here, the case where the overall weight is relatively small includes the overall weight of a vehicle (unloaded vehicle) whose loaded weight is minimum. The case where the overall weight is relatively large includes the overall weight of a vehicle whose loaded weight is maximum (maximum loaded weight).

Storage section 25 stores data for the broken line, solid line, and dashed-dotted line illustrated in FIG. 3 as a plurality of (here, three) tables, respectively. The number of tables corresponds to the number of stages indicated in accordance with the overall weight, and is not limited to three.

Control device 20 is connected to power control section 12. Control device 20 controls motor generator 14 via power control section 12. Specifically, based on the overall weight and the rotation speed of motor generator 14, control section 24 refers to the tables (referred with respect to FIG. 3) and controls motor generator 14. Specifically, control section 24 outputs a regenerative torque command value to power control section 12. Power control section 12 controls motor generator 14 in such a way that a power generation load in accordance with the regenerative torque command value is generated. As a result of the above, motor generator 14 can apply a power generation load in accordance with the overall weight to drive wheels 2 as regenerative torque. The above configuration allows vehicle 1 to obtain regenerative torque in accordance with the overall weight thereof.

FIG. 4 illustrates the relationship between the vehicle speed and the deceleration. In FIG. 4, the horizontal axis represents the vehicle speed [km/h], and the vertical axis represents the deceleration [m/s²]. In FIG. 4, the relationship between the vehicle speed and the deceleration is indicated by a broken line when the overall weight is relatively small, by a solid line when the overall weight is relatively large, and by a dashed-dotted line when the overall weight is intermediate. At any vehicle speed, the following are approximately the same: the deceleration when the overall weight is small (indicated by the broken line in FIG. 4), the deceleration when the overall weight is relatively large (indicated by solid line in FIG. 4), and the deceleration when the overall weight is intermediate (indicated by the dashed-dotted line in FIG. 4). This configuration allows the vehicle to obtain approximately the same deceleration regardless of its overall weight.

The above configuration prevents the deceleration from becoming too large, for example, in the case of a vehicle with a small overall weight (for example, unloaded vehicle), thus enabling the user to obtain the desired deceleration. In the case of a vehicle with a large overall weight, sufficient deceleration can be achieved, making it possible to maintain the inter-vehicle distance between the own vehicle and the vehicle ahead. This configuration thus enables cruise control that supports traveling to follow a vehicle ahead (following traveling) while maintaining the inter-vehicle distance.

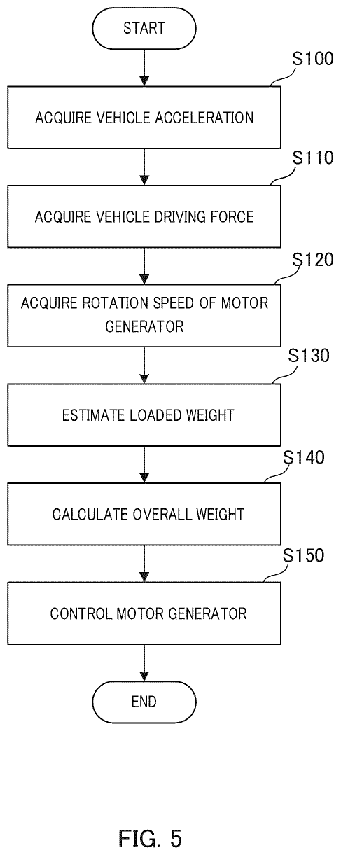

Next, an example of the operation of control device 20 will be described with reference to FIG. 5. FIG. 5 is a flowchart illustrating an example of the operation of control device 20. The flow begins when the power switch is turned on. Each function of control device 20 will be described as being implemented by a CPU.

First, in step S100, the CPU acquires the detection result (vehicle acceleration) of acceleration sensor 32.

Next, in step S110, the CPU acquires the detection result (vehicle driving force) of torque sensor 34.

Next, in step S120, the CPU acquires the detection result (rotation speed of motor generator 14) of rotation sensor 36.

Next, in step S130, the CPU estimates the loaded weight based on the relationship between the vehicle acceleration and the vehicle driving force.

Next, in step S140, the CPU calculates the overall weight by adding the loaded weight to the vehicle weight.

Next, in step S150, the CPU controls motor generator 14 based on the overall weight and the rotation speed of motor generator 14 with reference to the tables referred with respect to FIG. 3. After that, the flow illustrated in FIG. 5 ends. As a result of the above, motor generator 14 can apply a power generation load in accordance with the overall weight to drive wheels 2, as regenerative torque. The above configuration allows vehicle 1 to obtain regenerative torque in accordance with the overall weight thereof.

Vehicle control device 20 according to the above embodiment is a control device of vehicle 1 including motor generator 14 that generates regenerative torque contributing to deceleration of vehicle 1. Vehicle control device 20 includes overall weight calculation section 23 that calculates an overall weight of vehicle 1—the overall weight including a loaded weight that is a weight of a cargo loaded on a loading platform of vehicle 1; and control section 24 that controls motor generator 14 to change the regenerative torque according to the calculated overall weight.

The above configuration allows motor generator 14 to apply a power generation load in accordance with the overall weight to drive wheels 2 as regenerative torque. For example, when the overall weight is small, a small regenerative torque is applied to drive wheels 2. In addition, for example, when the overall weight is large, a large regenerative torque is applied to drive wheels 2. This configuration allows vehicle 1 to obtain approximately the same deceleration regardless of its overall weight.

In vehicle control device 20 according to the above embodiment, control section 24 further controls motor generator 14 to change the regenerative torque according to the rotation speed of motor generator 14. This makes it possible to apply appropriate regenerative torque to drive wheels 2 in accordance with the rotation speed of motor generator 14.

In vehicle control device 20 according to the above embodiment, control section 24 controls motor generator 14 by referring to a table, but the present disclosure is not limited to this configuration. For example, the control section may control motor generator 14 based on a predetermined mathematical expression. Such a mathematical expression can be determined by experiment or simulation.

In vehicle control device 20 according to the above embodiment, overall weight calculation section 23 calculates a total value (a sum of the loaded weight and the vehicle weight) as the overall weight, but the present disclosure is not limited to this configuration. For example, the weight of the person (people) in the vehicle may be added to the total value to obtain the overall weight.

Vehicle control device 20 according to the above embodiment includes loaded weight estimation section 22 estimating the loaded weight based on the vehicle driving force and the vehicle acceleration, but the present disclosure is not limited to this configuration. For example, a weight sensor may be provided on the loading platform on which a cargo is loaded. In this case, the weight sensor detects the weight of the cargo loaded on the loading platform. The detection result (loaded weight) of the weight sensor is input to control device 20.

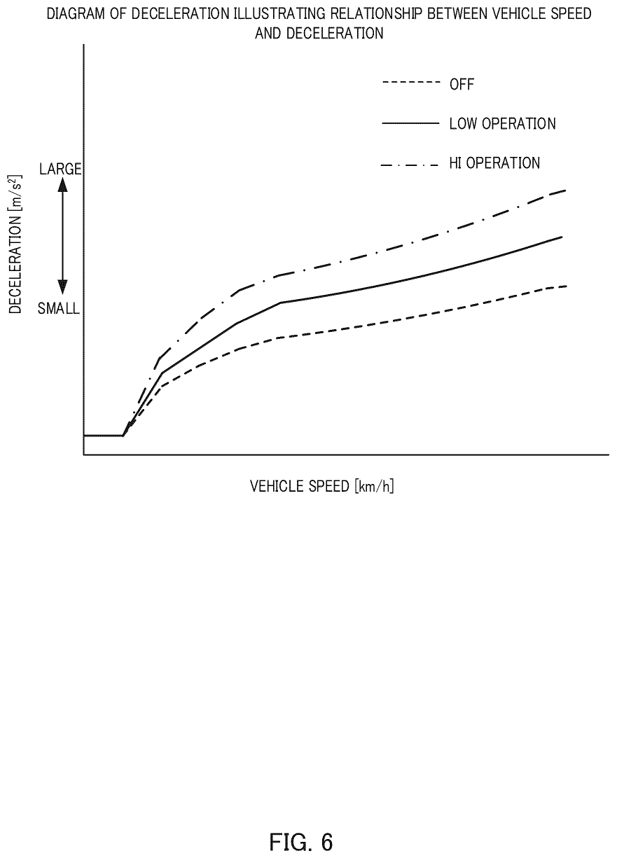

In general, a vehicle traveling downhill requires greater deceleration than a vehicle traveling on a flat road, and a vehicle traveling uphill may not require deceleration. In vehicle control device 20 according to the above embodiment, the user may set the magnitude of deceleration by operating a control lever. For example, as illustrated in FIG. 6, the regenerative torque may be set in three stages as follows: “HI operation” in which the regenerative torque is adjusted to obtain a large deceleration, “LOW operation” in which the regenerative torque is adjusted to obtain a small deceleration, and “OFF operation” in which the regenerative torque is not adjusted. In this case, a plurality of tables, each indicating the relationship between the rotation speed of motor generator 14 and the regenerative torque, respectively in stages according to the overall weight are divided into three groups. Control section 24 may control motor generator 14 by referring to any one of tables set in the groups.

The embodiment described above are merely an example of implementation of the present disclosure, and the technical scope of the present disclosure should not be construed as limited by the embodiment. That is, the present disclosure can be implemented in various forms without departing from the gist or main features thereof.

This application is entitled to and claims the benefit of Japanese Patent Application No. 2022-002568 filed on Jan. 11, 2022, the disclosure of which is incorporated herein by reference in its entirety.

### INDUSTRIAL APPLICABILITY

The present disclosure is suitably utilized for a vehicle including a control device that is required to obtain the regenerative torque in accordance with the overall weight of the vehicle.

### REFERENCE SIGNS LIST

1 Vehicle
2 Drive wheel
12 Power control section
14 Motor generator
16 Battery
20 Control device
21 Acquisition section
22 Loaded weight estimation section
23 Overall weight calculation section
24 Control section
25 Storage section
32 Acceleration sensor
34 Torque sensor
36 Rotation sensor

1. A control device of a vehicle that includes a motor generator generating regenerative torque contributing to deceleration of the vehicle, the control device comprising:
an overall weight calculation section that calculates an overall weight of the vehicle, the overall weight including a loaded weight that is a weight of a cargo loaded on a loading platform of the vehicle; and
a control section that controls the motor generator to change the regenerative torque according to the calculated overall weight.

2. The control device according to claim 1, wherein
the control section further controls the motor generator to change the regenerative torque according to a rotation speed of the motor generator.

3. The control device according to claim 2, further comprising:
a plurality of tables respectively in stages according to the overall weight, each table indicating a relationship between the rotation speed of the motor generator and the regenerative torque, wherein
the control section controls the motor generator by referring to a table selected from the plurality of tables based on the overall weight.

4. The control device according to claim 1, further comprising:
a loaded weight estimation section that estimates the loaded weight, wherein
the overall weight calculation section calculates a total value as the overall weight, the total value being a sum of the estimated loaded weight and a weight of the vehicle stored in advance.

5. The control device according to claim 4, wherein
the loaded weight estimation section estimates the loaded weight based on driving force of the vehicle and acceleration of the vehicle.

6. A vehicle comprising the control device according to claim 1.
